(19) United States
(12) Patent Application Publication
(10) Pub. No.: US 2004/0161322 A1
(43) Pub. Date: Aug. 19, 2004

(54) "Boat Tote", up-right, electric, boat loader and carrier

(76) Inventors: Kenneth Brachman, Vancouver, WA (US); Carol Brachman, Vancouver, WA (US)

Correspondence Address: Kenneth Brachman, 17401 SE 39th Street, Unit 147, Vancouvr, WA, 98683, US

(21) Appl. No.: 10/368,061

(22) Filed: Feb. 19, 2003

(51) Int. Cl. B60P 3/06

(52) U.S. Cl. 414/500

(57) ABSTRACT

This carrier allows you to carry your boat and tow your recreational trailer at the same time. Fitted with the lilting bed, a single person can load and unload the boat in less then a minute using an electrical, 12 volt wench. This carrier can be adjusted to fit any pick-up bed.

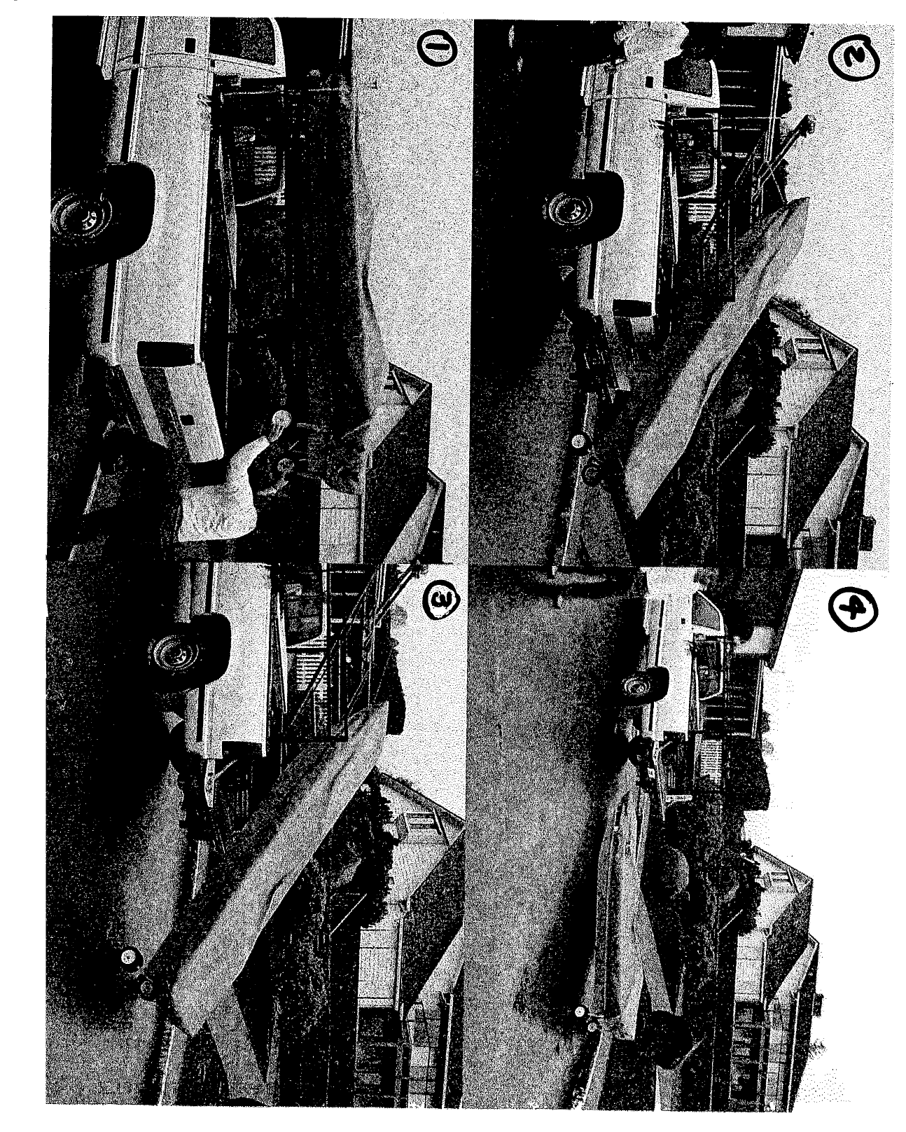

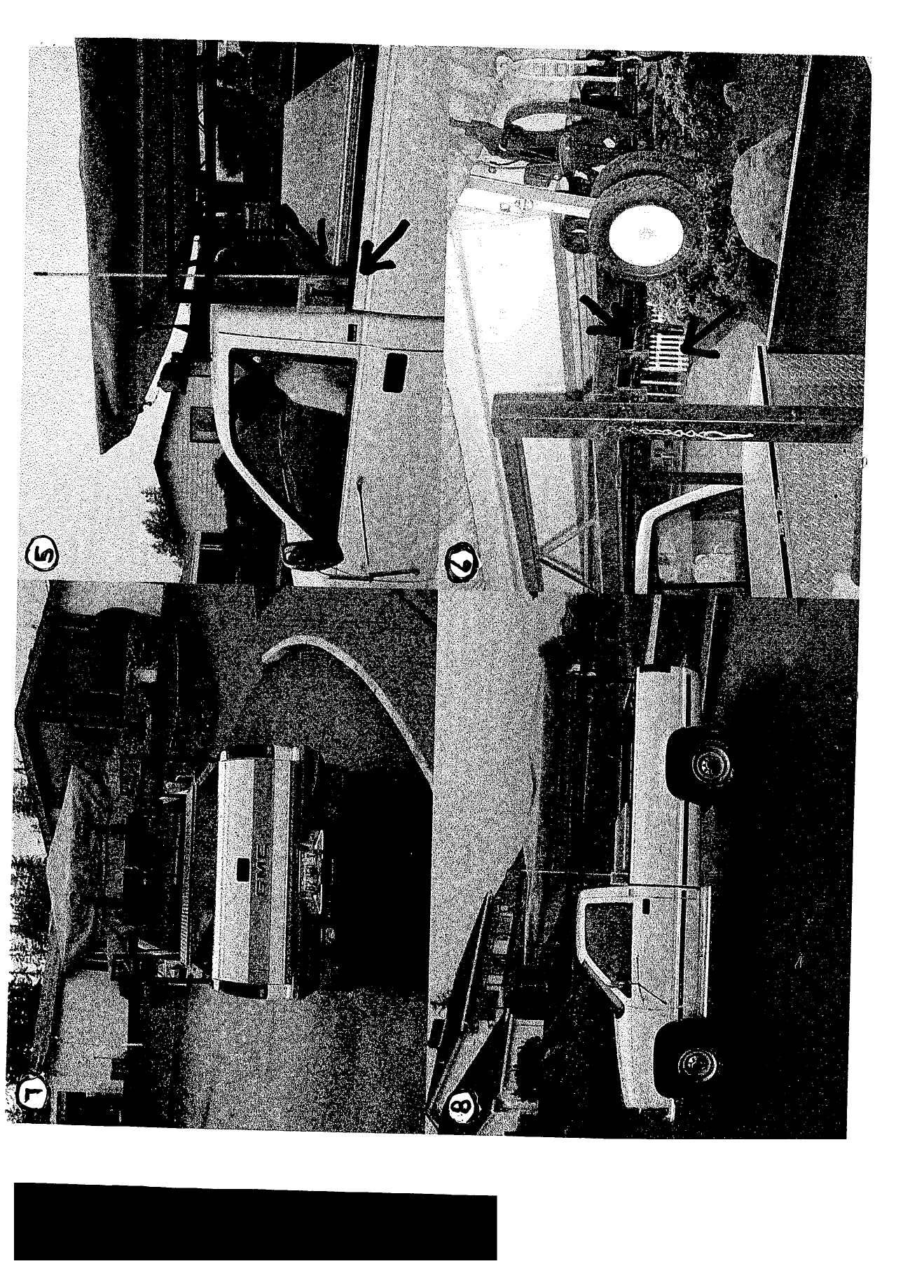

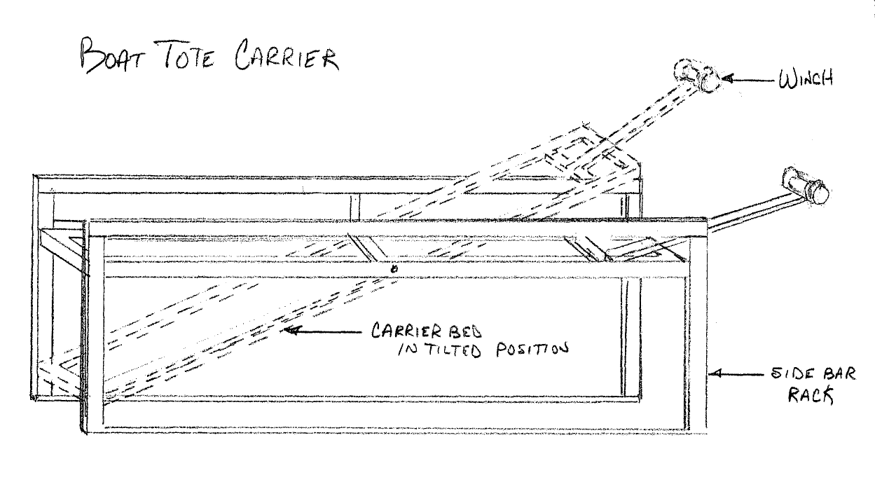

### BACKGROUND OF INVENTION

In May of 1994, We needed a way to carry my fishing boat and be able tow my travel trailer at the same time. We owned a one ton pickup truck with a standard lumber rack. We modified that rack to accommodate the loading of my boat. Over the last eight years, we developed the current model, which uses one winch instead of two and has a tilting carrying boat rack. In August of 2001 we took my set of drawings and specifications to a local welder for fabrication. We have been using this design successfully for the last year.

### BRIEF SUMMARY OF INVENTION

The function of the ‘Boat Tote” is to electrically lift a boat and it's equipment, and carry it atop a vehicle. Thus, allowing that vehicle to tow a trailer.

### DETAILED DESCRIPTION OF THE INVENTION

The ‘Boat Tote” consists of 3 parts: (1) A side bar boat carrying rack bolted to the inside walls of the bed of pick-up truck. (2) A carrier bed mounted between the bars that rotates from a level carrying position to a slant of up to 30% for loading and unloading. (3) A winch mounted to the front of the carrier bed so as to lift and lower the boat electrically.

To lower a boat to ground or water level, one needs only to un-center the boat to the rear of the carrier bed approximately 4 inches, which will tilt the carrier bed. By turning the electrical winch switch to the down position the boat will lower in less then on minute to the ground or directly to the water. To raise the boat to the top of the carrier, one needs only to align the boat, hook the winch cable to the front of the boat, and turn the electrical winch switch to the up or load position. The winch will pull the carrier bed down to approximately a 30 degree angle, lifting the boat from the ground or water level to the top of the carrier rack. The boat will roll on the carrier bed rollers until it reaches the center point at which time the carrier bed will return to a level position by it's self. Locking pins are then placed in the side bar rack and through the carrier bed and secured with pins for transportation.

### DESCRIPTIONS OF PHOTOGRAGHS OR DRAWINGS

(1): Photo showing unbalancing boat for unloading, (2): Photo showing tilted bed, (3): Photo boat rolling on ground and carrier rollers, (4): Photo showing boat fully on the ground, (5) Photo showing location of the winch and electrical control switch, (6): Photo showing safety lock pins, (7) Photo showing loaded boat from the rear, (8): Photo showing the carrier from the side, (9) Drawing showing the tilting carrier bed.

1. We claim that this is the only boat carrier that loads and carries; on a conventional pick-up truck; a boat and it's equipment in the up-right position; using an electric winch for loading and unloading.

2. We claim that this is the only boat carrier of this type that will electrically load and unload a boat, in the up-right position, from atop a conventional pickup in less then one minute.
